(19) United States
(12) Patent Application Publication
(10) Pub. No.: US 2006/0029726 A1
(43) Pub. Date: Feb. 9, 2006

(54) Method of fabricating PCB in parallel manner

(76) Inventors: Jee-Soo Mok, Chungcheongbuk-do (KR); Byung-Kook Sun, Seoul (KR); Chang-Kyu Song, Daejeon (KR); Jun-Heyoung Park, Chungcheongbuk-do (KR); Duck-Young Maeng, Chungcheongbuk-do (KR); Tae-Hoon Kim, Daejeon (KR)

Correspondence Address: GOTTLIEB RACKMAN & REISMAN PC, 270 MADISON AVENUE, 8TH FLOOR, NEW YORK, NY, 100160601, US

(21) Appl. No.: 10/948,875

(22) Filed: Sep. 24, 2004

(30) Foreign Application Priority Data
Aug. 5, 2004 (KR) 2004-61749

(51) Int. Cl. H01K 3/10

(52) U.S. Cl. 427/96.1; 156/289; 29/852

(57) ABSTRACT

Disclosed is a method of fabricating a multilayer PCB (MLB). More particularly, the present invention relates to a method of fabricating a multilayer PCB, in which plural circuit layers having insulating layers attached thereto and another circuit layer having no insulating layer are formed in a parallel manner according to separate processes, and laminated at one time, unlike fabrication of the multilayer PCB adopting a conventional build-up manner.

### BACKGROUND OF THE INVENTION

1. Field of the Invention

The present invention relates to a method of fabricating a multilayer printed circuit board (MLB; multilayer PCB). More particularly, the present invention pertains to a method of fabricating a multilayer PCB, in which a plurality of circuit layers (layers on which circuit patterns are formed) having insulating layers attached thereto are formed in a parallel manner according to separate processes and laminated at one time, unlike fabrication of a multilayer PCB adopting a conventional build-up manner.

2. Description of the Prior Art

In accordance with the trend toward small, slim, highly integrated, packaged, and portable electronic goods, realization of a fine-patterned, small-sized, and packaged multilayer PCB is in progress. Accordingly, substances for constituting the multilayer PCB are being replaced and the number of layers constituting the multilayer PCB is increasing so as to form a fine pattern on the multilayer PCB, to assure reliability of the multilayer PCB, and to improve the design density of the multilayer PCB. As for electronic parts, a dual in-line package (DIP) type of electronic part is apt to be replaced with a surface mount technology (SMT) type of electronic part, so a mount density on the electronic parts gradually increases. Furthermore, there remains a need to assure a sophisticated technology for designing a complicated PCB because it is needed for recent portable and multi-purpose electronic goods to function to transceive moving pictures and large amounts of data on-line.

A PCB is classified into the following types: a single-sided PCB in which a wire is formed on only one side of an insulating substrate, a double-sided PCB in which wires are formed on both sides of the insulating substrate, and a multilayer PCB (MLB) in which wires are formed on multiple layers. Conventionally, the single-sided PCB was popular because electronic parts generally have simple structures and their circuit patterns are not complicated. However, recently, the double-sided PCB or MLB is frequently being used in accordance with the increasing need for complicated, highly integrated, and fine circuits. Among them, the present invention discloses a method of fabricating the MLB.

The MLB is a PCB further including layers on which a wire is capable of being constructed so as to enlarge a wiring area. In detail, the MLB comprises inner and external layers, and the internal layers are each made of a thin core (T/C) as a raw material. Traditionally, the base MLB is a four-layered PCB consisting of two internal layers and two external layers attached to the internal layers using a prepreg. Accordingly, it should be understood that the term MLB as used herein is intended to include the PCB consisting of at least four layers. The MLB may alternatively include six, eight, and ten or more layers according to an increase in circuit complexity.

A power circuit, a ground circuit, a signal circuit and the like are constructed on the internal layers, and the prepreg is interposed between the internal and external layers, or between the external layers to realize isolation and attachment. At this time, the wires on each layer are connected to each other through via holes (through holes).

The MLB can have a desirably increased wiring density, but is disadvantageous in that its fabricating process is very complicated due to the increased wiring density. Particularly, since the internal layers fabricated in a conventional build-up manner cannot be modified after the fabrication of the MLB is completed, if it is found that the internal layers have defective portions, the MLB having defective internal layers must be discarded. Various inspection devices have been developed to compensate for the above disadvantages.

FIGS. 1a to 1m are sectional views stepwisely illustrating the fabrication of a six-layered PCB in the conventional build-up manner. In the specification of the present invention, the term “build-up manner” means a process which comprises forming internal layers and layering external layers one by one on the internal layers.

FIG. 1a is a sectional view of an unprocessed copper clad laminate (CCL) 101. Copper foils 102 are applied onto an insulating layer 103. Generally, the copper clad laminate acts as a substrate of a PCB, and means a thin laminate consisting of the insulating layer onto which copper is thinly applied.

The copper clad laminate is classified into a glass/epoxy CCL, a heat-resistant resin CCL, a paper/phenol CCL, a high-frequency CCL, a flexible CCL (polyimide film), a complex CCL and the like, in accordance with its use. Of them, the glass/epoxy CCL is most often used to fabricate double-sided PCBs and multilayer PCBs.

The glass/epoxy CCL consists of a reinforcing base substance in which an epoxy resin (combination of a resin and a hardening agent) is penetrated into a glass fiber, and a copper foil. The glass/epoxy CCL is graded FR-1 to FR-5, as prescribed by the National Electrical Manufacturers Association (NEMA), in accordance with the kind of reinforcing base substance and heat resistance. Traditionally, the FR-4 grade of glass/epoxy CCL is most frequently used, but recently, the demand for the FR-5 grade of glass/epoxy CCL, which has improved glass transition temperature (T_{g}), is growing.

Referring to FIG. 1b, the copper clad laminate 101 is drilled to form a via hole 104 for interlayer connection.

With reference to FIG. 1c, electroless-copper plating and electrolytic-copper plating processes are conducted. In this regard, the electroless-copper plating process is conducted before the electrolytic-copper plating process. The reason that the electroless-copper plating process is conducted before the electrolytic-copper plating process is that the electrolytic-copper plating process using electricity is not possible on the insulating layer. In other words, the electroless-copper plating process is conducted as a pretreatment process to form a thin conductive film needed to conduct the electrolytic-copper plating process. Since it is difficult to conduct the electroless-copper plating process and to assure economic efficiency, it is preferable that a conductive part of a circuit pattern be formed using the electrolytic-copper plating process.

Subsequently, a paste 106 is plugged in the via hole 104 so as to protect electroless and electrolytic copper clads 105 formed on a wall of the via hole 104. The paste is generally made of an insulating ink material, but may be made of a conductive paste according to the intended use of the PCB. The conductive paste may include only a metal mostly consisting of Cu, Ag, Au, Sn, or Pb, or a mixture of the metal and an organic adhesive. However, the plugging process of the via hole 104 using the paste may be omitted according to the purpose of the MLB.

In FIG. 1c, for convenience of understanding, the electroless and electrolytic copper clads 105 are illustrated as one layer without distinguishing two layers from each other.

In FIG. 1d, an etching resist pattern 107 is constructed to form a circuit pattern for an internal circuit.

The circuit pattern printed on an artwork film should be transferred onto a substrate so as to construct the etching resist pattern. There are various transferring methods, but one of the most frequently employed methods is to transfer a circuit pattern printed on an artwork film onto a photosensitive dry film using ultraviolet rays. In this regard, recently, a liquid photo resist (LPR) may be used instead of the dry film.

The dry film or LPR to which the circuit pattern is transferred acts as the etching resist 107, and when the substrate is dipped in an etching liquid as shown in FIG. 1e, the circuit pattern is formed.

After the formation of the circuit pattern, appearance of the circuit pattern is observed using an automatic optical inspection (AOI) device so as to evaluate whether an internal circuit is correctly formed or not, and the resulting substrate is subjected to a surface treatment, such as a black oxide treatment.

The AOI device is used to automatically inspect the appearance of a PCB. The device automatically inspects the appearance of the PCB employing an image sensor and a pattern recognition technology using a computer. After reading information regarding the pattern of an objective circuit using the image sensor, the AOI device compares the information to reference data to evaluate whether defects have occurred or not.

The minimum value of an annular ring of a land (a portion of the PCB on which parts are to be mounted) and a ground state of a power source can be inspected by use of the AOI device. Furthermore, the width of the circuit pattern can be measured and the omission of a hole can be detected. However, it is impossible to inspect the internal state of a hole.

The black oxide treatment is conducted so as to improve adhesion strength and heat resistance before an internal layer having the circuit pattern is attached to an external layer.

In FIG. 1f, resin-coated copper (RCC) is applied to both sides of the resulting substrate. The RCC consists of a substrate in which a copper foil 109 is formed on only one side of a resin layer 108, and the resin layer 108 acts as an insulator between the circuit layers.

In FIG. 1g, a blind via hole 110 is formed to electrically connect the internal and external layers to each other. The blind via hole may be formed using a mechanical drill, but since it is required to conduct a more precise process than in the case of processing a through hole, it is preferable to use an yttrium aluminum garnet (YAG) laser beam or CO₂ laser beam. The YAG laser beam can drill both a copper foil and an insulating layer, but the CO₂ laser beam can drill only the insulating layer.

In FIG. 1h, the external layer 111 is formed according to a plating process.

In FIG. 1i, the external layer 111 formed as shown in FIG. 1h is patterned according to the same procedure as the formation of the circuit pattern of the internal layer. The patterned external layer 111 is then inspected in terms of the circuit and subjected to a surface treatment, as in the case of the circuit pattern of the internal layer.

In FIG. 1j, additional RCC is applied to both sides of the resulting substrate. This RCC includes a resin layer 112 and a copper foil 113 coated on one side of the resin layer 112, and the resin layer 112 acts as an insulator.

In FIG. 1k, a blind via hole 114 is formed to electrically connect the external layers to each other using the laser beam as described above.

In FIG. 1l, the additional external layer 115 is formed according to a plating process.

In FIG. 1m, the additional external layer 115 is patterned according to the same procedure as the external layer 111, and the circuits of the patterned external layer 115 are then inspected and the layer is subjected to a surface treatment.

The number of layers constituting the multilayer PCB may be continuously increased by repeating the lamination of layers, the construction of the circuit patterns, the inspection of the circuit patterns, and the surface treatment of the resulting structure.

Subsequently, a photo-solder resist and a Ni/Au layer are coated on the resulting circuit pattern, thereby forming a six-layered PCB.

In detail, when a photo-solder resist (PSR) pattern is formed on a portion of the MLB, on which other substrates or chips are not mounted, and the Ni/Au layer is plated on the photo-solder resist pattern, the photo-solder resist pattern acts as a plating resist, and thus, the Ni/Au layer is plated on only another portion of the MLB, on which other substrates or chips are mounted. In this respect, the plating processes of Ni and Au are sequentially carried out. The plating of the Ni and Au is a step which ends the fabrication process of the MLB, thereby preventing an exposed copper foil portion not covered with the solder resist from oxidizing, improving solderability of parts mounted on the MLB, and providing excellent conductivity.

A conventional method of fabricating a PCB has a limit in coping with the recent trend of slimness and miniaturization the electronic goods, and is insufficiently competitive in terms of fabrication costs when a multipurpose PCB is fabricated according to the conventional method. However, currently, the selling price of electronic parts is falling, and it is required to shorten a fabrication period according to the great advances in the electronic parts industry.

With respect to the above trend, there are difficulties in minimizing fabrication costs and in shortening a fabrication time of the PCB by employing the conventional method which comprises forming the via holes using a laser beam in the conventional build-up manner, plating walls of the via holes to achieve an interlayer connection, and sequentially laminating layers.

The conventional build-up manner is disadvantageous in that when the number of layers constituting the MLB is increased, the forming of via holes using the laser beam, the laminating of the layers, the plating, the inspection, and the surface treatment are sequentially repeated, thereby prolonging the fabrication time of the MLB, and it is difficult to inspect the MLB during the fabrication of the desired MLB, thus undesirably increasing the defective proportion of the MLB, resulting in increased fabrication costs of the MLB.

Additionally, the conventional method, in which the via holes are formed in the circuit layer of the MLB to achieve the interlayer electric connection, the walls of the via holes are plated with copper, and the via holes are plugged with paste to protect the copper clad on the via holes, is disadvantageous in that the plugging process of the via holes using the paste is additionally carried out after the walls of the via holes are plated with copper.

Furthermore, the insulating layer, consisting of dielectric resin, of the MLB has a higher impedance than the circuit layer, and the impedance effects the operation of the circuit. The impedance value of the insulating layer depends on the thickness of the insulating layer, and the physical properties of the dielectric resin, that is, the dielectric constant, mass, and volume of the dielectric resin. Hence, there remains a need to develop a method of easily controlling the impedance of the insulating layer.

WO 2001/39267 discloses a process of fabricating a multilayer PCB, in which single-sided PCBs are laminated to both sides of a base layer, including an insulating substrate and circuits formed on one or both sides of the insulating substrate, using adhesive layers, and in which the resulting structure is pressed one time.

A section of the multilayer PCB fabricated according to the above patent is the same as that of the multilayer PCB fabricated in a build-up manner, and a completely hardened insulating substrate is used instead of a semi-hardened prepreg.

The present invention provides a method of fabricating a multilayer PCB, which adopts an improved batch lamination method simpler than that disclosed in the above patent.

### SUMMARY OF THE INVENTION

Therefore, the present invention has been made keeping in mind the above disadvantages of a conventional build-up process as disclosed in the prior arts, and an object of the present invention is to provide a method of fabricating a multilayer PCB, in which circuit layers having circuit patterns and insulating layers are formed in a parallel manner in separate processes, and they are alternately arranged and laminated at one time to form a product, thereby reducing fabrication costs, and minimizing fabrication time. Furthermore, circuits of internal layers are inspected after the layers are separately processed, thereby reducing defective portions.

The above object can be accomplished by providing a method of fabricating a multilayer PCB in a parallel manner. The method includes forming a first circuit layer, through which a first via hole for an electrical connection between upper and lower sides thereof is formed, and on which a first circuit pattern is formed; coating an insulator on one side of the first circuit layer to insulate the first circuit layer from other circuit layers; forming a second circuit layer, through which a second via hole for an electrical connection between upper and lower sides thereof is formed, and on which a second circuit pattern is formed; preliminarily laminating the second circuit layer on a side of the first circuit layer on which the insulator is coated; and pressing the first and second circuit layers.

More preferably, in the method of fabricating the multilayer PCB in the parallel manner according to the present invention, the coating of the insulator includes coating the flat-type insulator, to which a release film is attached, on one side of the first circuit layer; forming a third via hole through a portion of the insulator corresponding in position to the first via hole of the first circuit layer; plugging a conductive paste in the third via hole of the insulator; and removing the release film from the insulator.

More preferably, in the method of fabricating the multilayer PCB in a parallel manner according to the present invention, the forming of the first or second circuit layers includes forming the first or second via holes through a copper clad laminate; copper-plating the copper clad laminate and walls of the first or second via holes; and forming the first or second circuit patterns on the copper clad laminate to form a predetermined number of circuit layers.

More preferably, in the method of fabricating the multilayer PCB in a parallel manner according to the present invention, the forming of the first or second circuit layers includes forming the first or second via holes through a copper clad laminate; plating walls of the first or second via holes to plug the first or second via holes; and forming the first or second circuit patterns on the copper clad laminate.

More preferably, in the method of fabricating the multilayer PCB in a parallel manner according to the present invention, the forming of the first or second circuit layers includes forming the first or second via holes through a copper clad laminate; plugging a conductive paste in the first or second via holes; and forming the first or second circuit patterns on the copper clad laminate.

More preferably, the method of fabricating the multilayer PCB in the parallel manner according to the present invention further includes preliminarily laminating a third circuit layer, which has an insulator coated on one side thereof, on the lower side of the second circuit layer after the preliminary lamination of the second circuit layer.

### BRIEF DESCRIPTION OF THE DRAWINGS

The above and other objects, features and other advantages of the present invention will be more clearly understood from the following detailed description taken in conjunction with the accompanying drawings, in which:

FIGS. 1a to 1m are sectional views illustrating fabrication of a conventional multilayer PCB in a build-up manner;

FIGS. 2a to 2e are sectional views illustrating formation of a circuit layer of an internal circuit according to a conventional technology;

FIGS. 3a to 3d are sectional views illustrating formation of a circuit layer according to a fine hole plating process of the present invention;

FIGS. 4a to 4d are sectional views illustrating formation of a circuit layer according to a conductive paste plugging process of the present invention;

FIGS. 5a to 5e are sectional views illustrating fabrication of a multilayer PCB according to the present invention;

FIG. 6 illustrates the fabrication of the multilayer PCB in a parallel manner according to the present invention; and

FIG. 7 is a sectional view of a six-layered PCB fabricated according to the present invention.

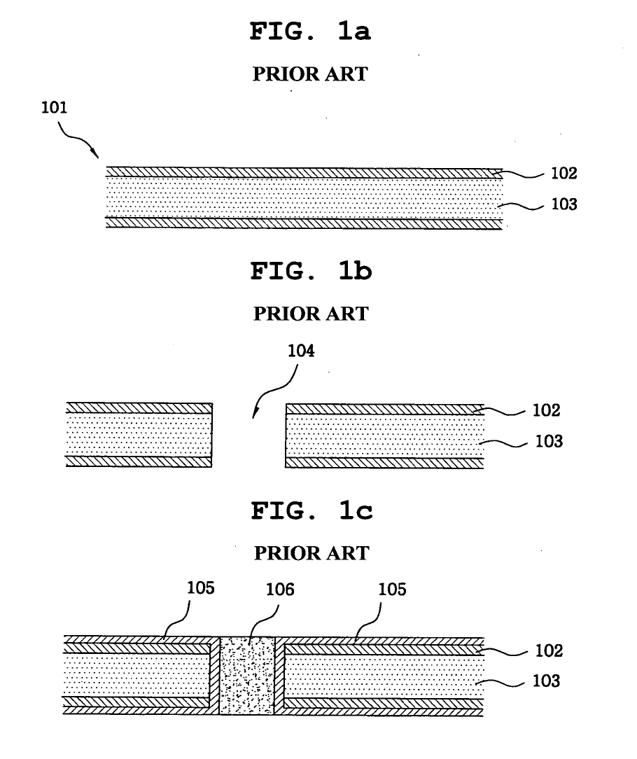

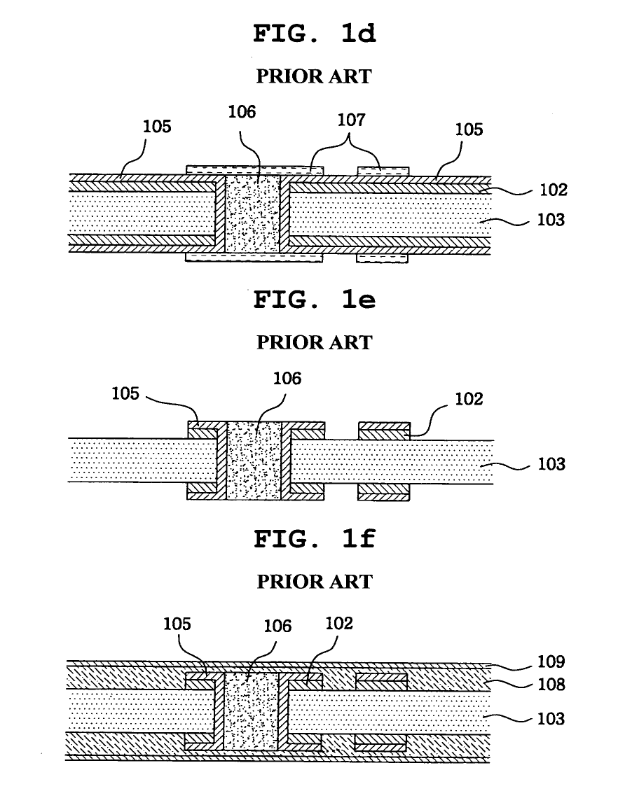

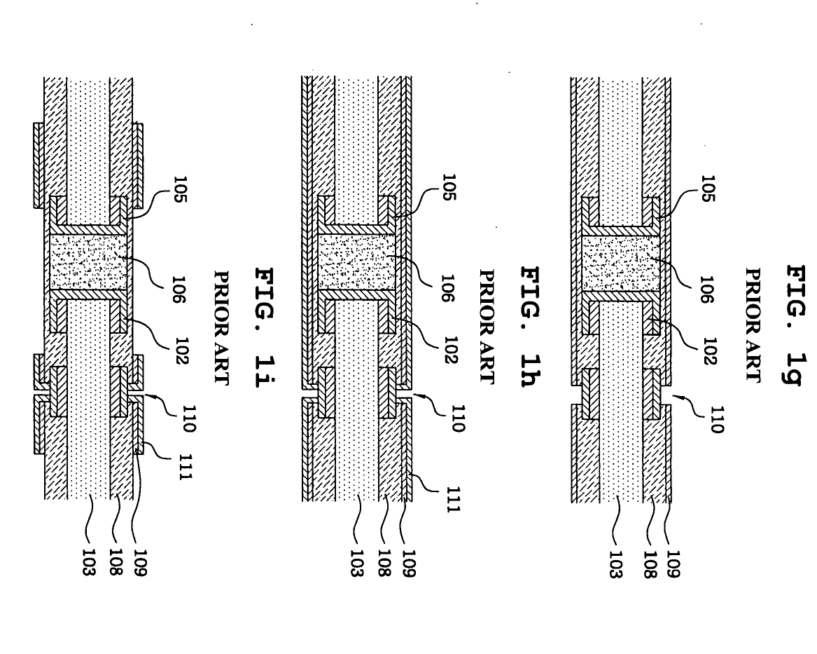

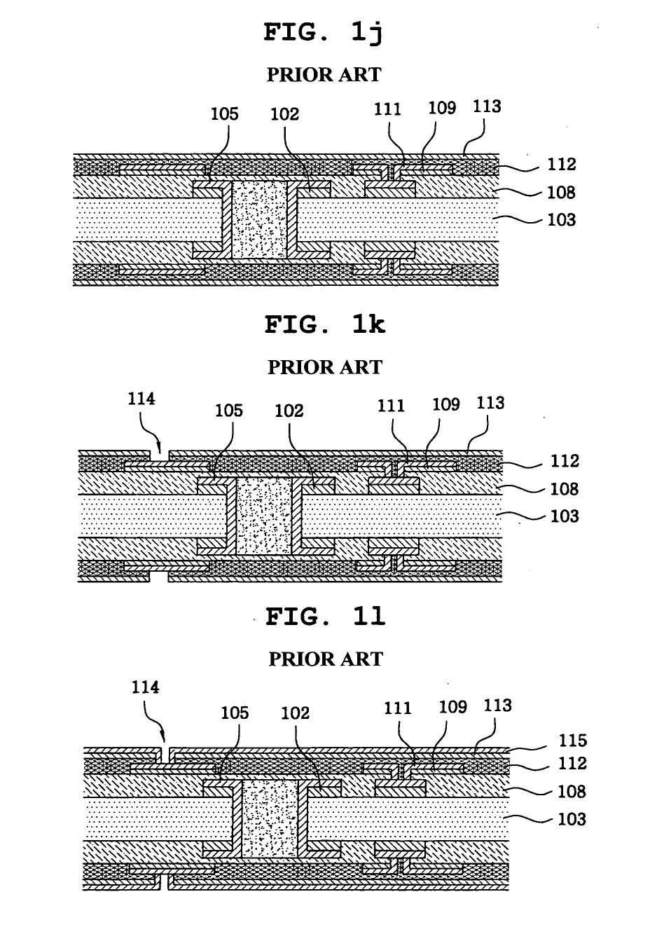

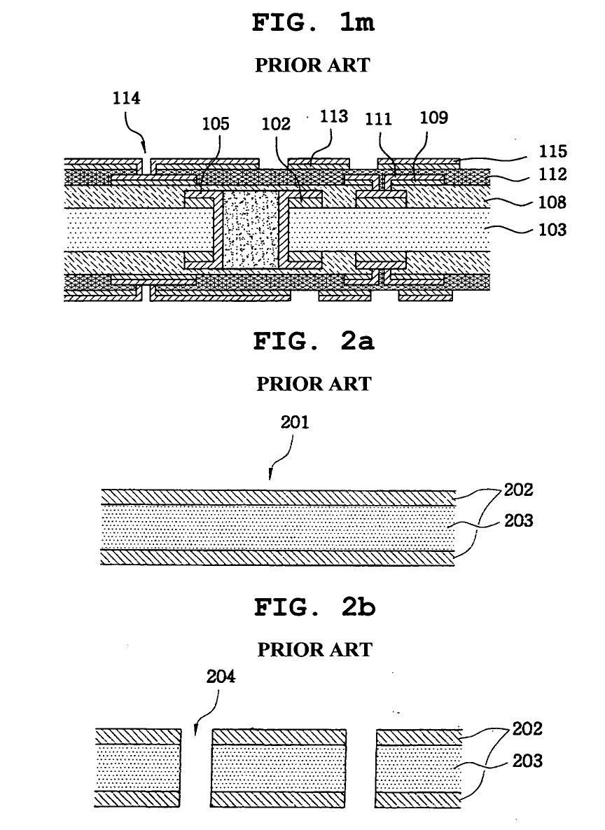

### DETAILED DESCRIPTION OF THE INVENTION

Hereinafter, a detailed description will be given of the present invention, referring to the drawings.

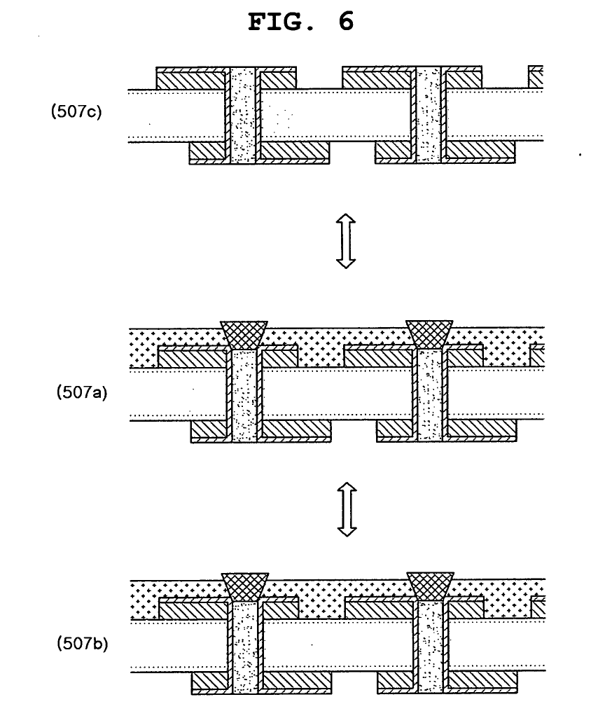

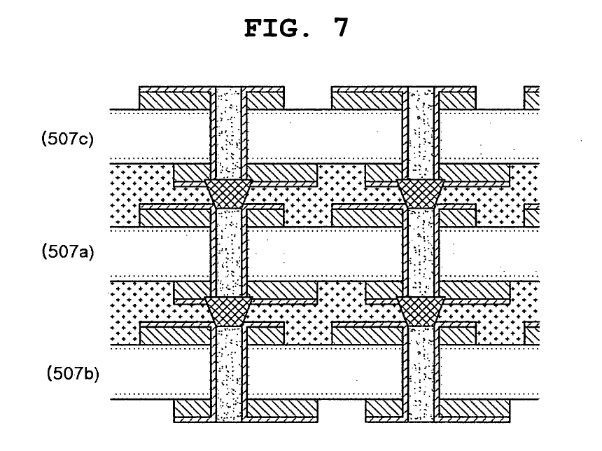

FIG. 6 illustrates fabrication of a multilayer PCB in a parallel manner according to the present invention. Circuit layers 507a, 507b having insulating layers attached thereto and a circuit layer 507c having no insulating layer are formed in a parallel manner according to separate processes, arranged as shown in FIG. 6, and pressed in the direction of the arrows to form a six-layered PCB as shown in FIG. 7.

Different processes of forming the circuit layers in the parallel manner according to the present invention will be described.

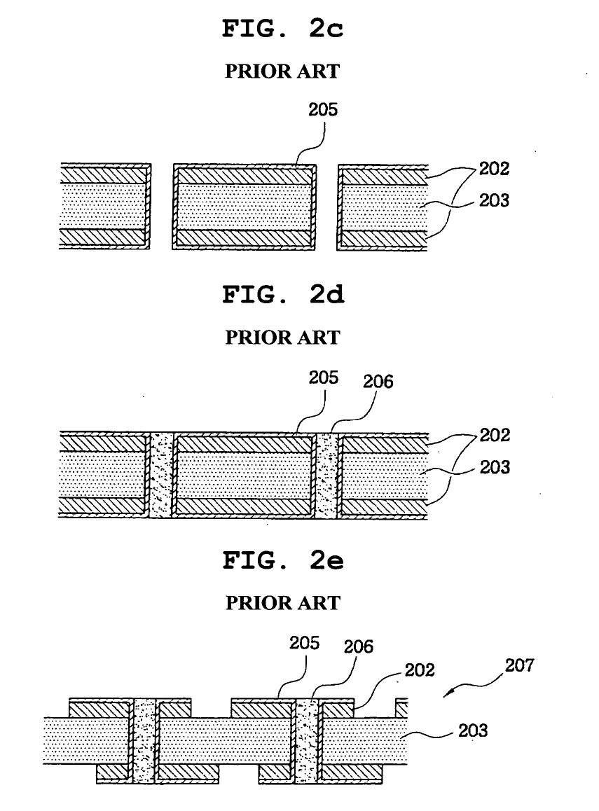

FIGS. 2a to 2e illustrate an embodiment of fabrication methods of a circuit layer constituting a multilayer PCB, which is adopted in a method of fabricating the multilayer PCB in a parallel manner according to the present invention.

With reference to FIG. 2a, a typical copper clad laminate 201 and copper foils 202 applied onto both sides of an insulating layer 203 are illustrated.

As shown in FIG. 2b, the copper clad laminate 201 is drilled to form via holes 204 therethrough.

Subsequently, as shown in FIG. 2c, electroless-copper plating and electrolytic-copper plating processes are carried out to form a conductive layer 205.

Successively, as shown in FIG. 2d, a conductive paste 206 is plugged in the via holes 204 so as to protect the via holes 204.

Next, as shown in FIG. 2e, a circuit pattern is formed according to a traditional circuit patterning process such as an etching process.

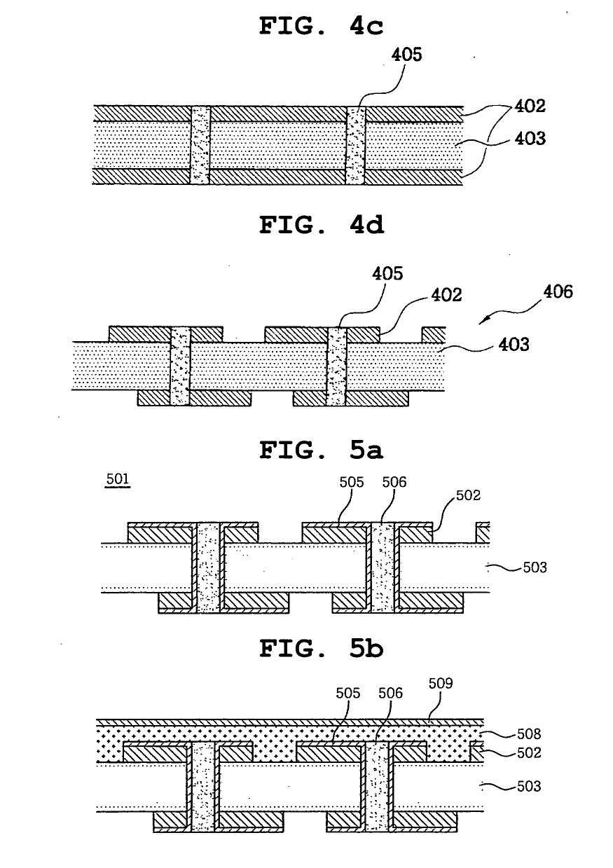

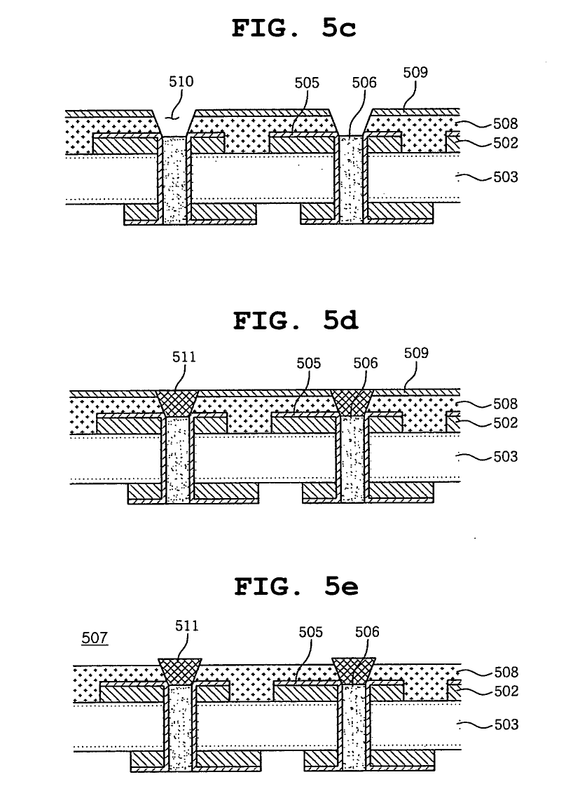

A circuit layer may be used as a circuit layer 501 of FIG. 5a according to the present invention.

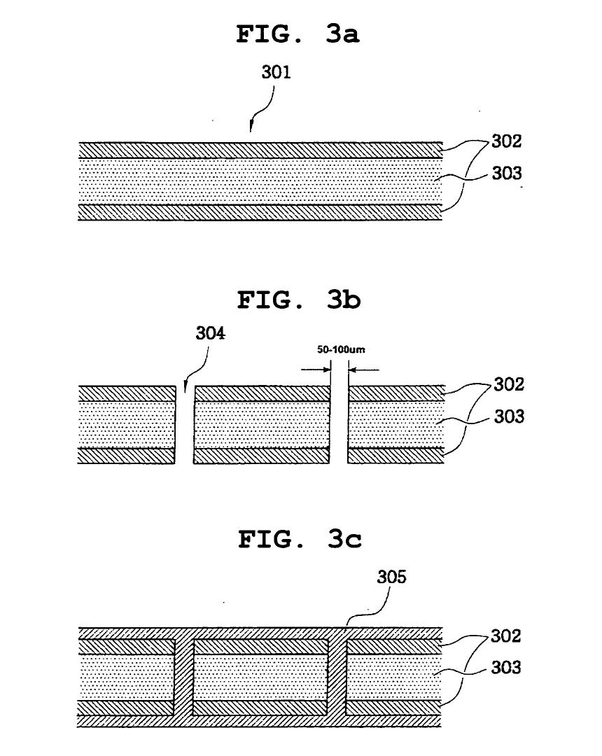

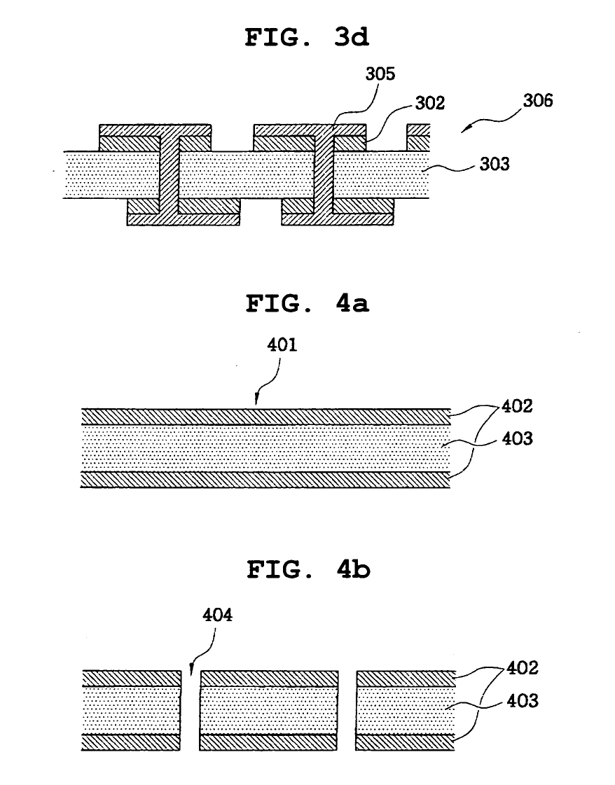

FIGS. 3a to 3d are another embodiment of fabrication methods of a circuit layer constituting a multilayer PCB, which is adopted in a method of fabricating the multilayer PCB in a parallel manner according to the present invention, and in which via holes are formed and then plugged by a plating process.

Referring to FIG. 3a, there is illustrated a typical copper clad laminate 301, and copper foils 302 are applied onto both sides of an insulating layer 303.

As described above, there are many kinds of copper clad laminates, but the copper clad laminate having the thin copper foil with a thickness of about 3-5 μm is used in this embodiment. The reason for this is that laser drill or fine hole mechanical processes are conducted so as to process fine via holes with a relatively small diameter. That is to say, the copper foil must be thin so as to accomodate the via holes.

In FIG. 3b, the via holes 304 are formed through the copper clad laminate. The via holes are processed using a YAG laser beam or a CO₂ laser beam so that their diameters each are 50 to 100 μm. The diameter of the above via hole is relatively small in comparison with a via hole having a diameter ranging from 200 to 300 μm of a traditionally multilayer PCB, so an additional plugging process using the paste may be omitted.

In FIG. 3c, the copper clad laminate in which the via holes 304 are formed is subjected to electroless plating and electrolytic plating processes to plate both sides of the copper clad laminate and walls of the via holes. As shown in FIG. 3c, plated layers 305 are formed on both sides of the copper clad laminate, and the via holes 304 are plugged by the plating.

Conventionally, when the plugging of the via holes is required in the course of processing the via holes, as shown in FIGS. 2a to 2e, electroless plating and electrolytic plating processes are conducted to plate the walls of the via holes and an insulating ink is plugged in the remaining spaces of the via holes. However, in the present invention, the via holes 304 are formed in such a way that their initial diameters are relatively small, and the via holes are plugged according to an electric plating process.

Accordingly, in the present invention, the plugging process using the paste may be omitted even though it is necessary to conduct the plugging process in accordance with the purpose of a PCB.

In FIG. 3d, a circuit pattern is formed according to a circuit patterning process such as an etching process. A circuit layer 306 may be used as a circuit layer 501 of FIG. 5a in the method according to the present invention.

FIGS. 4a to 4d are another embodiment of fabrication methods of a circuit layer constituting a multilayer PCB, which is adopted in a method of fabricating the multilayer PCB in a parallel manner according to the present invention, and in which a conductive paste is plugged in via holes.

Referring to FIG. 4a, a typical copper clad laminate 401 is illustrated, and copper foils 402 are applied onto both sides of an insulating layer 403.

As shown in FIG. 4b, the via holes 404 are formed through a drilling process.

Subsequently, as in FIG. 4c, the conductive paste 405 is plugged in the via holes 404.

Next, as shown in FIG. 4d, a circuit pattern is formed according to a circuit patterning process such as an etching process. In this regard, in this embodiment, no plating process is conducted in the course of forming a circuit layer.

Furthermore, the circuit layer 406 may be used as a circuit layer 501 of FIG. 5a according to the present invention.

After fabrication according to three procedures of FIGS. 2a to 2e, FIGS. 3a to 3d, and FIGS. 4a to 4d, the circuit layers are subjected to a post-treatment process, such as a circuit inspection process, using an AOI device and a surface treatment process.

It is to be understood that modifications to the formation of the circuit pattern as well as the etching process will be apparent to those skilled in the art.

FIGS. 5a to 5e are sectional views stepwisely illustrating the fabrication of a multilayer PCB according to the present invention.

Referring to FIG. 5a, a sectional view of a first circuit layer 501 is illustrated, on which a via hole for electrical connection and a circuit pattern are formed, as shown in FIGS. 2a to 2e. A circuit layer, formed according to the procedures of FIGS. 3a to 3d, or FIGS. 4a to 4d, or a circuit layer formed according to a process of fabricating a double-sided PCB known in the art may be used as the first circuit layer 501.

Subsequently, as shown in FIG. 5b, an insulator 508+509 is coated on one side of the first circuit layer 501 on which the circuit pattern is formed. The insulator 508+509 consists of a thermosetting resin 508 in a b-stage state and a PET coat 509. In this respect, the coating of the insulator consisting of the thermosetting resin 508 and PET coat 509 may be conducted, or the coating of the coat 509 may be conducted after lamination of the thermosetting resin 508 is carried out. The insulator 508+509 is used to isolate circuit patterns of circuit layers during a subsequent batch lamination process of the multilayer PCB. The thermosetting resin 508 is used to assure shapability in the course of laminating the circuit layers.

As shown in FIG. 5c, a blind via hole (BVH) 510 is formed in a side of the first circuit layer 501, on which the insulator is coated, by a drill. The BVH 510 may be formed using a mechanical drill, but since it is required to conduct a more precise process than in the case of processing a through hole, it is preferable to use an yttrium aluminum garnet (YAG) laser beam or CO₂ laser beam. The YAG laser beam can drill both a copper foil and an insulating layer, but the CO₂ laser beam can drill only the insulating layer.

Successively, as shown in FIG. 5d, a conductive paste 511 is plugged in the BVH 510. In this regard, the BVH 510 is formed so that it is deep enough to connect the conductive paste 511 to a paste 506 or a conductive layer 505 constituting a wall of the via hole of the first circuit layer 501 in the course of plugging the conductive paste 511. Preferably, the BVH 510 is formed so that its depth is the same as a thickness of the thermosetting resin 508, or is deeper than the thickness of the thermosetting resin 508 by 1-2 μm.

In FIG. 5e, the PET coat 509 is stripped.

The first circuit layer 507a, to which the insulating layer is attached, a second circuit layer 507b formed according to the same procedure as the first circuit layer, and a circuit layer 507c, to which no insulating layer are attached, are arranged as shown in FIG. 6. The arrangement may be conducted using a jig employed in a typical method of fabricating a PCB.

Next, the first circuit layer 507a, second circuit layer 507b, and circuit layer 507c are pressed upward and downward by a press, and heated to thermally harden the thermosetting resin 508 coated on the first and second circuit layers 507a, 507b.

At this time, before the thermosetting resin 508 is thermally hardened, since it has predetermined shapability when it is pressed, the thermosetting resin 508 is shaped and hardened so that its shape is changed in accordance with circuit patterns formed on the first circuit layer 507a, second circuit layer 507b, and circuit layer 507c, thereby enabling the circuit layers to come into close contact with each other.

FIG. 7 is a sectional view of a six-layered PCB produced according to the present invention.

Circuit patterns formed on circuit layers 507a, 507b, 507c are isolated from each other by thermosetting resins 508 of insulators 508+509 formed on the circuit layers 507a, 507b, and via holes of the circuit layers 507a, 507b, 507c are electrically connected to each other through conductive pasts 511 plugged in BVHs 510 formed in the thermosetting resins 508.

The specification of the present invention embodies use of circuit layers formed according to the procedure of FIGS. 2a to 2e, but it is to be understood that modifications, such as applications of the method according to the present invention to the circuit layers formed according to the procedures of FIGS. 3a to 3d or 4a to 4d, will be apparent to those skilled in the art.

In the method of fabricating the multilayer PCB in a parallel manner according to the present invention, the number of circuit layers used depends on the number of layers of the multilayer PCB to be fabricated. For example, a four-layered PCB includes one circuit layer to which an insulating layer is attached, and one circuit layer to which no insulating layer is attached, a six-layered PCB includes two circuit layers to which insulating layers are attached, and one circuit layer to which no insulating layer is attached, and an eight-layered PCB includes three circuit layers to which insulating layers are attached, and one circuit layer to which no insulating layer is attached.

In the case of the multilayer PCB fabricated in a so-called build-up manner, it has a structure in which an insulating layer is laminated on one double-sided PCB and single-sided PCBs are sequentially laminated on the resulting double-sided PCB. However, in the case of the multilayer PCB fabricated in parallel or batch lamination manners, it has a structure in which plural double-sided PCBs are continuously laminated while insulating layers are interposed between neighboring double-sided PCBs.

Therefore, because of different structures of the PCBs, it is possible to distinguish how a PCB is fabricated by observing a section of the PCB.

Unlike conventional technology, in which freedom is significantly reduced in the course of designing a via hole because of a limitation of a conventional process of fabricating a PCB, in a method of fabricating a PCB according to the present invention, such a limitation can be avoided, and thus, the length of the wiring is reduced and it is possible to design a selective through connection between desired layers, resulting in reduced areas of products and a reduced number of layers.

In the course of processing a circuit layer according to the present invention, a diameter of the via hole is designed small to fill up the small hole through a plating process, thereby omitting a plugging process, resulting in assurance of simplification and rapidness.

In the course of processing an insulating layer according to the present invention, a semi-hardened resin is attached to one side of the circuit layer to form the insulating layer, and thus, it is possible to freely control a thickness of the insulating layer, thereby reducing an effect caused by impedance and assuring excellent interfacial matching and shapability when it is combined with the circuit layer.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

What is claimed is:

1. A method of fabricating a printed circuit board in a parallel manner, comprising:
forming a first circuit layer, through which a first via hole for an electrical connection between upper and lower sides thereof is formed, and on which a first circuit pattern is formed;
coating an insulator on one side of the first circuit layer to insulate the first circuit layer from other circuit layers;
forming a second circuit layer, through which a second via hole for an electrical connection between upper and lower sides thereof is formed, and on which a second circuit pattern is formed;
preliminarily laminating the second circuit layer on a side of the first circuit layer on which the insulator is coated; and
pressing the first and second circuit layers.

2. The method as set forth in claim 1, wherein the coating of the insulator comprises:
coating the flat-type insulator, to which a release film is attached, on one side of the first circuit layer;
forming a third via hole through a portion of the insulator corresponding in position to the first via hole of the first circuit layer;
plugging a conductive paste in the third via hole of the insulator; and
removing the release film from the insulator.

3. The method as set forth in claim 1, wherein the forming of the first or second circuit layers comprises:
forming the first or second via holes through a copper clad laminate;
copper-plating the copper clad laminate and walls of the first or second via holes; and
forming the first or second circuit patterns on the copper clad laminate to form a predetermined number of circuit layers.

4. The method as set forth in claim 1, wherein the forming of the first or second circuit layers comprises:
forming the first or second via holes through a copper clad laminate;
plating walls of the first or second via holes to plug the first or second via holes; and
forming the first or second circuit patterns on the copper clad laminate.

5. The method as set forth in claim 1, wherein the forming of the first or second circuit layers comprises:
forming the first or second via holes through a copper clad laminate;
plugging a conductive paste in the first or second via holes; and
forming the first or second circuit patterns on the copper clad laminate.

6. The method as set forth in claim 1, further comprising preliminarily laminating a third circuit layer, which has the insulator coated on one side thereof, on the lower side of the second circuit layer after the preliminary laminating of the second circuit layer.
